(19) United States
(12) Patent Application Publication
(10) Pub. No.: US 2026/0331396 A1
(43) Pub. Date: Oct. 22, 2026

(54) SLIDER DEVICE FOR USE IN A SWITCHING MECHANISM

(71) Applicant: EATON INTELLIGENT POWER LIMITED, Dublin 4 (IE)

(72) Inventors: Sumit Rajan VARMA, Solapur, Maharashtra (IN); Aishwarya GAIKWAD, Pune, Maharashtra (IN); Bjoern NITSCHKE, Leverkusen, NRW (DE)

(21) Appl. No.: 19/105,709

(22) PCT Filed: Oct. 12, 2023
(86) PCT No.: PCT/EP2023/025432

§ 371 Date: Feb. 21, 2025

(30) Foreign Application Priority Data
Oct. 14, 2022 (IN) 202211058933
Nov. 28, 2022 (GB) 2217783.6

(51) Int. Cl. H01H 13/14; H01H 1/20; H01H 1/24; H01H 9/26; H01H 13/52

(52) U.S. Cl. CPC H01H 13/14; H01H 1/2025; H01H 1/245; H01H 9/26; H01H 13/52

(57) ABSTRACT

Some embodiments relate to a slider device for use in a switching mechanism having a plurality of fixed contacts, an apparatus and switch comprising the slider device, and a method of operating the switch. The slider device comprises a body portion extending along a first axis between a first end and a second end. The slider device also comprises a first fixed arm extending away from the body portion in a first direction. The slider device also comprises a second fixed arm extending away from the body portion in a second direction. The first direction is different to the second direction. The first direction and the second direction each extend at an angle to the first axis. The first arm is configured to carry a first conductor and the second arm is configured to carry a second conductor.

### CROSS-REFERENCE TO RELATED APPLICATIONS

This application is a national phase filing under 35 C.F.R. § 371 of and claims priority to PCT Patent Application No. PCT/EP2023/025432, filed on Oct. 12, 2023, which claims the priority benefit under 35 U.S.C. § 119 of British Patent Application No. 2217783.6, filed on Nov. 28, 2022, and Indian Patent Application No. 202211058933, filed on Oct. 14, 2022, the contents of which are hereby incorporated in their entireties by reference.

### FIELD

This relates to a slider device for use in a switching mechanism. In particular, the slider device can be used to provide a switching mechanism with physical separation between two conductors carried by the slider device. An apparatus which incorporates the slider device and first and second conductors is also described herein, along with a switch having a switching mechanism which incorporates said apparatus and a method of operating the switch.

### BACKGROUND

A current conduction path can be defined along an external current line and through a switch (or switching mechanism). The switch or switching mechanism can be electrically connected to one or more external current lines by way of, for example, electrical terminals or contacts, such that one or more current conduction paths are formed through the switch. Such switches can use a switching mechanism to open and close the one or more current conduction paths through the switch. One approach is to use a switching mechanism comprising a slider device, where the slider device is configured to carry a moveable conductor. The slider device can move between a position where the moveable conductor is electrically connected to one or more external current lines (to close one or more current conduction paths through the switch) and a position where the moveable conductor is electrically separate from one or more external current lines (to open one or more current conduction paths through the switch).

It is desirable to provide a safe and robust slider device for use in a switching mechanism, which is also cost-effective and easy to manufacture. An improved slider device is desirable for switching applications including, for example, power transmission, industrial machinery, and control panels.

### SUMMARY

In a first aspect, a slider device is provided as defined in the first appended independent apparatus claim, with optional features defined in the dependent claims appended thereto. In a second aspect, an apparatus comprising said slider device is provided as defined in the second appended independent apparatus claim, with optional features defined in the dependent claims appended thereto. In a third aspect, a switch comprising said apparatus is provided as defined in the third appended independent apparatus claim, with optional features defined in the dependent claims appended thereto. In a fourth aspect, a method of operating the switch of the third aspect is provided as defined in the appended independent method claim. Any features described in relation to one particular aspect may be implemented as part of another aspect.

Described herein, in a first aspect of the specification, is a slider device for use in a switching mechanism having a plurality of fixed contacts. The slider device comprises a body portion extending along a first axis between a first end and a second end. The slider device comprises a first fixed arm extending away from the body portion in a first direction. The slider device comprises a second fixed arm extending away from the body portion in a second direction. The first direction is different to the second direction. The first direction and the second direction each extend at an angle to (or angle from) the first axis. The first arm is configured to carry a first conductor. The second arm is configured to carry a second conductor.

The slider device described herein can be used as part of a switch or switching mechanism to provide improved safety, the slider device being capable of providing improved electrical isolation between current conduction paths which pass through the switch. For example, a first external current line can be connected to a first pair of fixed electrical contacts of the switch, and a second external current line can be connected to a second pair of fixed electrical contacts of the switch. The slider device is configured to carry a first conductor and a second conductor. The two conductors can be positioned on the slider device such that, depending on the position of the slider device, the first conductor can provide an electrical connection between the first pair of fixed contacts to define a first current conduction path, and/or the second conductor can provide an electrical connection between the second pair of fixed contacts to define a second current conduction path.

In this scenario, by using a slider device with the first conductor carried by a first arm (which extends away from a central body portion) and the second conductor carried by a second arm (which extends away from the central body portion in a different direction), the slider device can provide physical separation (and thus electrical isolation) between the first conductor and the second conductor, and thus between the first current conduction path and the second current conduction path. For a switch of a given external housing size, this arrangement can provide a maximum physical distance between current conduction paths, facilitating a switch with improved or optimal creepage and/or clearance distance between current conduction paths.

Typical switches or switching mechanisms with a traditional arrangement of components can use conductors extending directly from a central slider device. This arrangement offers reduced electrical isolation between different conductors compared to the slider device described herein. This arrangement also necessitates the use of longer conductors extending from the slider device, which can be more prone to bending when subject to external forces. For example, when forced into electrical contact with fixed contacts, longer conductors such as these are likely to bend, and the contact pressure between the conductor and the fixed contacts will therefore be reduced. The slider device described herein uses rigid, fixed arms extending from the body portion to carry the first and second conductors. These fixed arms can be insulating, and can be integrally formed with the body portion and can allow a strong contact pressure to be provided between the conductors and the fixed contacts. A robust, reliable switching mechanism can therefore be provided through use of the slider device described herein.

Optionally, the first direction and the second direction are both perpendicular to the first axis. This arrangement may provide a maximum physical separation (and optimal electrical isolation) between the first and second conductors in the direction perpendicular to the first axis. Optionally, an angle between the first direction and the second direction about the first axis is 180 degrees. This arrangement may provide a maximum physical separation (and optimal electrical isolation) between the first and second conductors about the first axis. Optionally, wherein the first arm and the second arm are offset along the first axis. This arrangement may provide a maximum physical separation (and optimal electrical isolation) between the first and second conductors along the first axis.

Optionally, a first end of the first arm is attached to the body portion, a second end of the first arm comprises a first mounting portion configured to retain the first conductor, a first end of the second arm is attached to the body portion, and a second end of the second arm comprises a second mounting portion configured to retain the second conductor. The use of mounting portions may allow the conductors to be securely attached to the arms of the slider device.

Optionally, the first mounting portion is arranged to face in a direction (along the first axis) towards the first end of the body portion (in some examples, to face a plane defined by the first end of the body portion), and the second mounting portion is arranged to face in a direction (along the first axis) towards the second end of the body portion (in some examples, to face a plane defined by the second end of the body portion). Optionally, the first mounting portion is arranged to face in a direction opposite a direction in which the second mounting portion is configured to face. These arrangements may allow the slider device to be used as part of a switching mechanism which can simultaneously provide normally open and normally closed switching. For example, this arrangement may allowed the conductors to be mounted to the arms of the slider device such that the first conductor can contact a first pair of fixed contacts facing in one direction, and the second conductor can contact a second pair of fixed contacts facing in an opposite direction.

Optionally, the first conductor is arranged to contact a first pair of fixed contacts of the plurality of fixed contacts in a first plane (optionally perpendicular to the first axis), and the second conductor is arranged to contact a second pair of fixed contacts of the plurality of fixed contacts in a second plane (optionally perpendicular to the first axis). The first and second planes may be different. Having the two conductors contact the pairs of fixed contacts in this offset manner may facilitate provision of simultaneous normally open and normally closed switching within a more compact switching mechanism. Optionally, the first mounting portion comprises a first through-hole configured to interface with a protruding portion of the first conductor such that motion of the first conductor is constrained to movement along an axis parallel to the first axis by the first mounting portion, and the second mounting portion comprises a second through-hole configured to interface with a protruding portion of the second conductor such that motion of the second conductor is constrained to movement along an axis parallel to the first axis by the second mounting portion. Optionally, the first mounting portion comprises a first through-hole configured to interface with a protruding portion of the first conductor such that the first conductor can move along an axis parallel to the first axis and movement is restricted along axes perpendicular to the first axis. Optionally, the second mounting portion comprises a second through-hole configured to interface with a protruding portion of the second conductor such that the second conductor can move along an axis parallel to the first axis and movement is restricted along axes perpendicular to the first axis. By including a through-hole to constrain movement of the each conductor, the mounting portion can retain the conductor without any need for another intermediary component. Such a through-hole may allow the protruding portion of the conductor to be slotted into place and held without any further means of fastening or attachment. This may allow a modular manufacturing process with fast, easy assembly. The through-hole may be a slot, recess, window, or hole, as appropriate.

Optionally, the first mounting portion comprises a first guide-hole along an axis parallel to the first axis, the first guide-hole and the first conductor are configured to retain a first resilient member between them (the first resilient member retained within the first guide-hole by the first conductor), the second mounting portion comprises a second guide-hole along an axis parallel to the first axis, and the second guide-hole and the second conductor are configured to retain a second resilient member between them (the second resilient member retained within the second guide-hole by the second conductor). The first and second resilient members may be resiliently (e.g. elastically) deformable when a force is exerted on them. Resiliently deformable components may provide a substantially consistent response to external forces and pressures over the working life of the switch or switching mechanism. The use of the first and second resilient members may provide a strong contact pressure between the conductors and fixed contacts when they are in contact, giving a better electrical connection between conductor and fixed contacts.

Optionally, the first end of the body portion comprises a third guide-hole along the first axis, and the third guide-hole and an external housing are configured to retain a third resilient member between them (the third resilient member retained within the third guide-hole by the external housing). When released from compression, the third resilient member may allow a strong biasing force to be provided which can rapidly accelerate the slider device along the first axis in order to move the slider device between different positions. This may provide a rapid switching mechanism.

Optionally, the first resilient member is a spring and/or the second resilient member is a spring, optionally a compression spring. Optionally, the third resilient member is a spring, optionally a compression spring. Springs may be cheap to purchase and/or manufacture.

Optionally, the second end of the body portion comprises an engagement portion configured to receive an external force for operating the switching mechanism. The engagement portion may be shaped such that the external force can be applied over a surface area larger than the second end of the body portion, reducing the likelihood of damaging the slider device. The engagement portion may also be shaped such that it can interface with external components configured to provide the external force, such as cams, motors, and pistons, etc.

Optionally, the slider device is integrally formed. By manufacturing the moveable slider device as a single component, manufacturing time and cost may be reduced. This may also allow a more rigid slider device to be formed, with a greater resistance to bending under the application of external forces. Optionally, the body portion, the first fixed arm, and the second fixed arm are manufactured as separate components and attached or coupled together to form the slider device. This may allow the constituent components of the slider device to be replaced or repaired if they wear or break during use of the slider device.

Optionally, the slider device is formed from an insulating material. Optionally, the insulating material is plastic. By using a slider device made of an insulting material, current conduction paths through the device may be physically separated and electrically isolated from each other, improving safety.

In a second aspect of the specification, an apparatus for use in a switching mechanism having a plurality of fixed conductors is provided. The apparatus comprises the slider device of the first aspect as described above. The apparatus comprises a first conductor carried by the first arm and a second conductor carried by the second arm. The apparatus optionally comprises a first resilient member retained by the first guide-hole and the first conductor and/or a second resilient member retained by the second guide-hole and the second conductor. The apparatus can be assembled using a modular manufacturing process with quick and cheap assembly.

Optionally, the first conductor and second conductor each comprise: a first contact plate, a second contact plate, and a U-shaped conductive track arranged between the first contact plate and second contact plate. The use of a U-shaped conductive track to connect the first and second contact plates increases the volume of the conductor, which help in thermal performance of the device, since the temperature rise caused by current flow through the first and second conductors under normal operating conditions of the apparatus is reduced.

Optionally, the first conductor is integrally formed of a conductive material. Optionally, the second conductor is integrally formed of a conductive material. Optionally, the conductive material is sheet metal. By manufacturing the conductor as a single component, manufacturing time and cost may be reduced. Making the conductor(s) from sheet metal may reduce the amount of material required to produce the conductors, increasing efficiency and further reducing costs.

Optionally, the first conductor and second conductor are the same shape. This may allow conductor components to be interchangeably used and installed as part of the apparatus as first or second conductors. Manufacturing and assembly costs may therefore be reduced.

In a third aspect of the specification, a switch configured for connection to one or more external current lines is provided. The switch comprises an external housing. The switch comprises a switching mechanism arranged at least partially within the external housing. The switching mechanism comprises the apparatus of the second aspect as described above. The switching mechanism optionally comprises a third resilient member retained within the third guide-hole by the external housing. The switching mechanism comprises a plurality of fixed contacts, the plurality of fixed contacts comprising a first pair of fixed contacts configured to be coupled to one or more first external current lines of the one or more external current lines, and a second pair of fixed contacts configured to be coupled to one or more second external current lines of the one or more external current lines.

In response to application of an external force to the engagement portion directed along the first axis and towards the first end of the body portion, the slider device is configured to move along the first axis from a first position to a second position, and thereby cause the third resilient member to resiliently deform. The deformation of the third resilient member causes the slider device to move along the first axis from a first position to a second position. In response to the remove of the external force, the third resilient member is arrange to urge the slider device to move along the first axis from the second position to the first position.

Optionally, in one of the first and second positions, the first resilient member provides a first force on the first conductor which creates an electrical connection between the first conductor and the first pair of fixed contacts such that a current can flow through the one or more first external current lines, and the second conductor is electrically separate from the second pair of fixed contacts, and in the other of the first and second positions, the first conductor is electrically separate from the first pair of fixed contacts, and the second resilient member provides a second force on the second conductor which creates an electrical connection between the second conductor and the second pair of fixed contacts such that a current can flow through the one or more second external current lines. This arrangement allows the switch to simultaneously open one current conduction path and close another current conduction path as the slider device moves from one position to the other, and vice versa as the slider device moves back to the original position. As such, the switch provides a switching mechanism which can simultaneously provide normally open and normally closed switching. This arrangement may provide, for example, an emergency switch which, when turned ‘on’ simultaneously opens one or more current conduction paths (to e.g. power off industrial machinery) and closes one or more other current conduction paths (to e.g. power on a back-up lighting system).

Optionally, the first conductor is arranged such that, in one of the first and second positions, the first contact plate and second contact plate of the first conductor form the electrical connection with the first pair of fixed contacts such that the current can flow through the one or more first external current lines, and the second conductor is arranged such that, in the other of the first and second positions, the first contact plate and second contact plate of the second conductor form the electrical connection with the second pair of fixed contacts such that the current can flow through the one or more second external current lines. The use of contact plates on the conductors aligned with the fixed contacts may provide a secure and reliable electrical connection.

In a fourth aspect of the specification, a method of operating the switch configured for connection to one or more external current lines of the third aspect is provided. The method comprises: applying the external force to the engagement portion; in response to the application of the external force, moving, by the deformation of the third resilient member, the slider device along the first axis from the first position to the second position and thereby resiliently deforming the third resilient member along the first axis; removing the external force; and in response to the removal of the external force, urging, by the third resilient member, the slider device from the second position to the first position.

It will be understood that any of the features described above with reference to the device of the first, second, and third aspects may be provided in any suitable combination. Moreover, any such features may be combined with any features of the method of the fourth aspect, or vice-verse, as appropriate.

### BRIEF DESCRIPTION OF THE DRAWINGS

The following description is with reference to the following figures.

FIG. 1: FIG. 1A shows a schematic cross section of a slider device in accordance with an example of the first aspect, FIG. 1B shows a schematic cross section of a slider device in accordance with another example of the first aspect, and FIG. 1C shows a schematic cross section of a slider device in accordance with a further example of the first aspect.

FIG. 2: FIGS. 2A and 2B show perspective views of an example slider device with a cascaded, or stepped, arm arrangement.

FIG. 3: FIG. 3A shows a perspective view of an apparatus in accordance with an example of the second aspect, and FIG. 3B shows an exploded view of the apparatus of FIG. 3A.

FIG. 4: FIG. 4A shows a perspective view of an example conductor, and FIG. 4B shows a cross section of the example conductor of FIG. 4A.

FIG. 5 FIG. 5A shows a cross section of a switch in accordance with an example of the third aspect, where the slider device is in a first position, and FIG. 5B shows a cross section of the switch of FIG. 5A, where the slider device is in a second position.

FIG. 6: FIG. 6A shows a perspective view of a switch in accordance with an example of the third aspect, and FIG. 6B shows an exploded view of the switch of FIG. 6A.

FIG. 7 illustrates a method in accordance with the fourth aspect.

### DETAILED DESCRIPTION

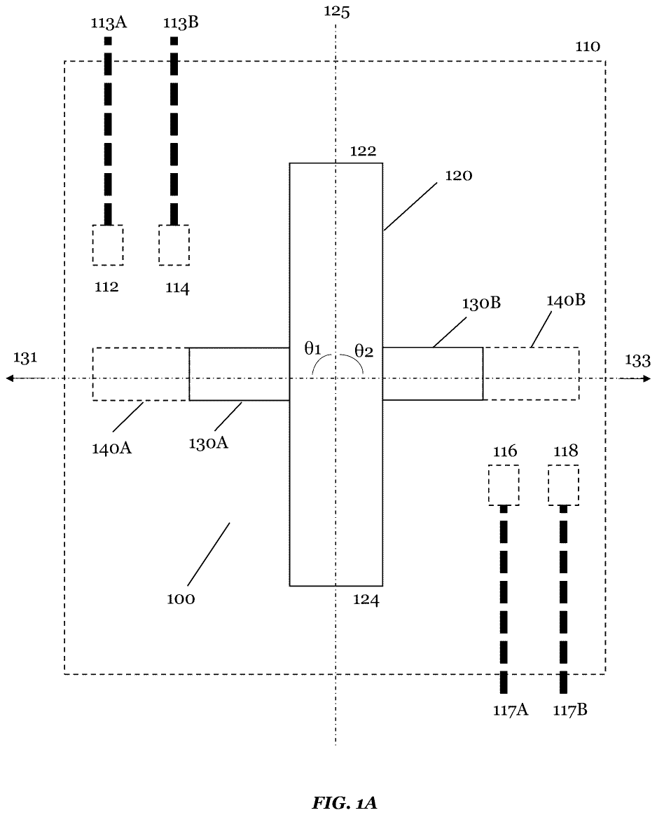

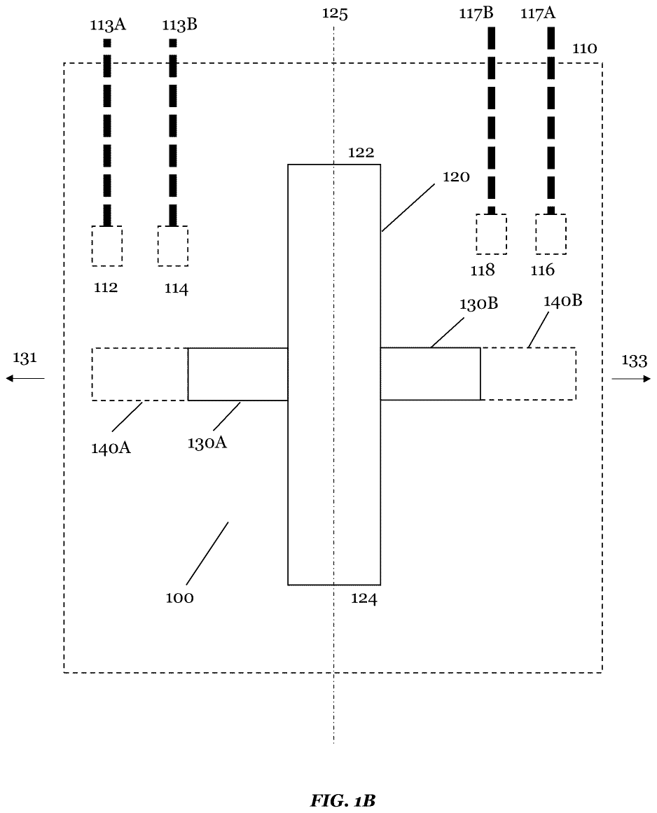

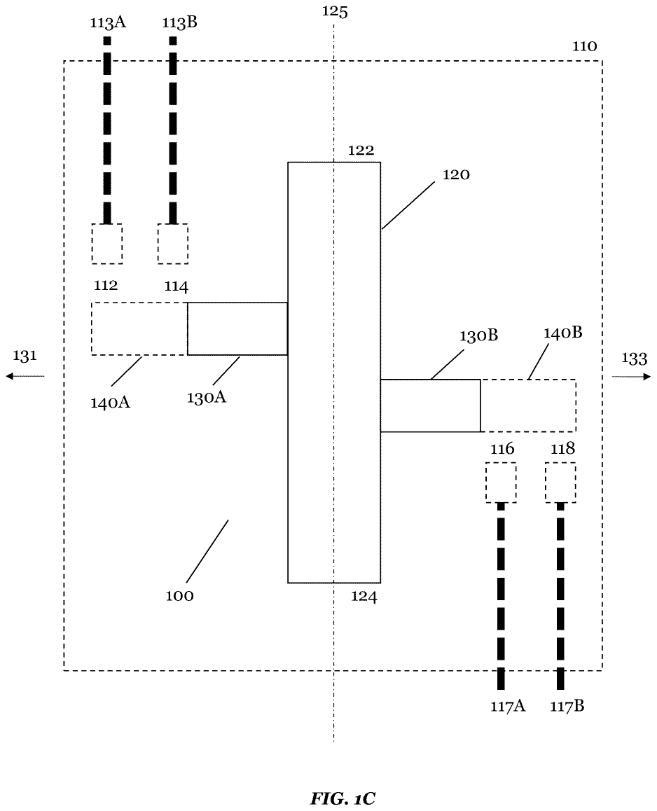

With reference to FIG. 1 (FIGS. 1A, 1B, and 1C), a slider device 100 for use in a switching mechanism 110 having a plurality of fixed contacts 112, 114, 116, 118 is described. In the following description, the terms “switch” and “switching mechanism” are used, but the features described herein may be implemented in any other device with an electrical switching action (such as a contactor, breaker, or electrical isolation device).

The switching mechanism 110 may comprise a plurality of components and/or structures which interact to open and close current conduction path(s). The fixed contacts 112, 114, 116, 118 may be a subset of these components. The slider device 100 (i.e. a device which is configured to move by sliding, or movement in a linear direction) may also be one of these components.

The fixed contacts 112, 114, 116, 118 may be any suitable electrical contacts which can be fixed or secured in place. For example, they may be electrical terminals mechanically or chemically coupled or otherwise joined or bonded to an external housing or surface.

The fixed contacts may be formed from any suitable electrically conducting material, optionally copper. The fixed contacts may configured to be connected to one or more external current lines 113, 117. For example, a first fixed contact 112 of the plurality of fixed contacts may be coupled to a first portion of a first external current line 113A, a second fixed contact 114 may be coupled to a second portion of the first external current line 113B, a third fixed contact 116 may be coupled to a first portion of a second external current line 117A, and a fourth fixed contact 118 may be coupled to a second portion of the second external current line 117B.

In this scenario, by creating an electrical connection between the first fixed contact 112 and the second fixed contact 114, a first current conduction path can be defined along the first external current line 113. This electrical connection can be created, for example, by placing a first conductor 140A in electrical contact with both the first fixed contact 112 and the second fixed contact 114. By creating an electrical connection between the third fixed contact 116 and fourth fixed contact 118, a second current conduction path can be defined along the second external current line 117. This electrical connection can be created, for example, by placing a second conductor 140B in electrical contact with both the third fixed contact 116 and the fourth fixed contact 118.

The slider device 100 is configured to carry such first and second conductors 140A, 140B. Through movement (i.e. sliding) of the slider device, these first and second conductors be used to open (i.e. through bringing the conductor(s) into contact with their corresponding fixed contacts) and close (i.e. through removing the conductor(s) from contact with their corresponding fixed contacts) one or more current conduction paths through the switching mechanism 110 (e.g. through current lines 113, 117).

It will be understood that this scenario is by way of example only, and the switching mechanism may contain more or fewer electrical contacts, which may be coupled to one or more external current lines in any suitable manner. The first and second conductors of the slider device may be arranged to contact the fixed contacts in any manner suitable to define one or more current conduction paths through the switching mechanism.

In one example (not illustrated), the first and second fixed contacts 112, 114 may not be connected to external current line 113 (or there may not be an external current line 113), such that the switching mechanism provides a single-pole switching mechanism for switching external current line 117. In another example, the third and fourth fixed contacts 116, 118 may not be connected to external current line 117 (or there may not be an external current line 117), such that the switching mechanism provides a single-pole switching mechanism for switching external current line 113.

The slider device 100 comprises a body portion 120 (i.e. a main body of the slider device) which extends between a first end 122 and a second end 124 along a first axis 125 (i.e. the first axis passes through the first end and second end of the body portion). For example, the first axis 125 can pass exactly or approximately through the centre of the first and second ends 122, 124. The first end and/or second ends of the body portion may be flat (see e.g. FIG. 1). Alternatively, the first end and/or second ends of the body portion can be rounded or can have any other suitable shape depending on the configuration of slider device 100. The first end and the second end of the body portion can be configured to receive forces directed substantially along the first axis 125, which can cause movement of the slider device 100 along the first axis 125 within the switching mechanism 110.

The slider device 100 comprises a first fixed arm 130A extending away from the body portion 120 in a first direction 131. The first direction extends at an angle θ1 to the first axis 125. In other words, the first arm 130A protrudes from the body portion 120 of the slider device 100 in a first direction 131. The first arm 130A is attached to the main body portion 120 and is fixedly retained or held by the body portion. The first arm 130A can be attached to the body portion 120 using any suitable means that provides adequate bending stiffness (i.e. sufficient bending stiffness that external forces acting on the first fixed arm do not cause significant deformation of the slider device and do not cause a significant deflection of the first arm away from the first direction).

The slider device 100 comprises a second fixed arm 130B extending away from the body portion in a second direction 133. The second direction extends at an angle θ2 to the first axis 125. Again, the second arm 130B protrudes from the body portion 120 of the slider device 100 in a second direction 133. The second arm 130B is also attached to the main body portion 120 and is fixedly retained or held by the body portion. The second arm 130B can be attached the body portion using any suitable means that provides adequate bending stiffness (i.e. sufficient bending stiffness that external forces acting on the second fixed arm do not cause significant deformation of the slider device and do not cause a significant deflection of the second arm away from the second direction).

The first direction 131 and the second direction 133 are different. That is, there is a non-zero angle between the first direction and the second directions. The angle θ1 between the first axis 125 and the first direction 131 and the angle θ2 between the first axis 125 and the second direction 133 are both non-zero angles (i.e. the first direction and the second direction are not along or parallel to the first axis). For example, the first direction 131 and the second direction 133 may both extend at an angle between 30 and 150 degrees, optionally between 60 and 120 degrees to the first axis 125. In particular examples, the first direction 131 and the second direction 133 may be perpendicular to the first axis 125 (see e.g. FIG. 1).

The first arm 130A is configured to carry a first conductor 140A and the second arm 130B is configured to carry a second conductor 140B. In other words, the first conductor 140A and second conductor 140B are moved in direct response to movement of the slider device 100. The first arm 130A may be configured to couple to or retain the first conductor 140A without the need for any separate coupling component(s), and the second arm 130B may be configured to couple to or retain the second conductor 140B without the need for any separate coupling component(s). This can reduce complexity of the device, making assembly and manufacture quicker and cheaper.

In one example (see e.g. FIG. 1A), the fixed contacts 112, 114, 116, 118 of the switching mechanism 110 are arranged such that, with the slider device 100 in one position (e.g. a first position), the first conductor 140A is in electrical contact with fixed contacts of the plurality of fixed contacts (e.g. fixed contacts 112, 114), whilst the second conductor 140B is electrically separated from the fixed contacts. With the slider device 100 in another position (e.g. a second position), the first conductor 140A is electrically separated from the fixed contacts, whilst the second conductor 140B is in electrical contact with other fixed contacts of the plurality of contacts (e.g. fixed contacts 116, 118). This arrangement can provide a switching mechanism with simultaneous normally open and normally closed switching (i.e. in one position of the slider device, a first current conduction path is closed and a second current conduction path is open, whilst in another position of the slider device, the first current conduction path is open and the second current conduction path is closed).

In another example shown in FIG. 1B, the fixed contacts of the switching mechanism 110 are arranged such that, with the slider device in a particular position, the first conductor 140A and the second conductor 140B can simultaneously be brought into electrical contact with fixed contacts of the plurality of fixed contacts, such that a plurality of current conduction lines through the switching mechanism can simultaneously be closed. This arrangement may allow two or more current conduction paths (i.e. two or more separate circuits) to be simultaneously switched on or off based on a single input to the switching mechanism 110.

Again, it will be understood that these scenarios are by way of example only, and the switching mechanism may, for example, contain more or fewer current conduction paths. The arms may also be offset along the first axis in some other examples, as is illustrated in FIG. 1C.

Regardless of the arrangement of fixed contacts relative to the first and second conductors 140A, 140B, the slider device 100 may provide physical separation (and thus electrical isolation) between the first conductor 140A and the second conductor 140B. This means that separate external current lines 113, 117 attached to the fixed contacts can be electrically isolated from each other in an effective manner.

In the design of electronic components and products, ‘clearance’ distance refers to the shortest distance in air between two particular conductors, and ‘creepage’ distance refers to the shortest distance across an insulating surface between two particular conductors. Electronic components and products which operate at high voltages and high currents often have to provide particular clearance and creepage distances between conductors to meet e.g. national, regional, and/or international safety standards. For a given size of housing in which the switching mechanism 110 is to be installed, the slider device 100 described herein can provide improved or optimal clearance and creepage distance between the first conductor 140A and the second conductor 140B, preventing different current conduction paths through the switch from e.g. short circuiting, electrically interfering with one another, etc. In other words, the distance in air and the distance across insulating material between the first conductor 140A and the second conductor 140B may be as large as allowed by the size of the housing in which the switching mechanism 110 is contained due to the specific arrangement of the slider design.

The slider device 100 may be integrally formed. In other words, the body portion 120, the first fixed arm 130A, and the second fixed arm 130B may be formed of one piece of material. In such examples, the integrally formed slider device may be manufactured using an injection moulding process or a 3D printing process, for example. Integrally forming the slider device can facilitate a more rigid and stable component, which is less prone to bending under external forces. An integrally formed slider device can also be manufactured more quickly and cheaply, and is thus suited to production at large volumes. For example, producing an integrally formed component by injection moulding requires fewer moulds than to produce the portions separately, and the portions do not need to be assembled together. The slider 100 may thus be more robust.

Alternatively, the body portion 120, first fixed arm 130A, and second fixed arm 130B of the slider device 100 may be formed as separate components and attached together during the manufacturing process. For example, the first arm 130A and the second arm 130B may be bonded onto the body portion 120, or may interlock with the body portion 120 via a snap-fit mechanism. This may allow for modular manufacturing of the switch, as well as facilitating replacement of one or more of the constituent components of the slider device if they wear or break. Lifetime of the slider may therefore be improved.

The slider device 100, whether integrally formed or made from separate components, may be formed of an electrically insulating material, optionally plastic. Using a slider device made of an insulating material may provide the switching mechanism in which it is used with improved safety; the slider device 100 is configured to create a physical separation between the first conductor and the second conductor by interposing an insulating material between the first and second conductors, thereby creating electrical isolation between any circuits coupled to these conductors (i.e. via the fixed contacts of the switching mechanism).

A specific example of a slider device (such as device 100) is described below in more detail.

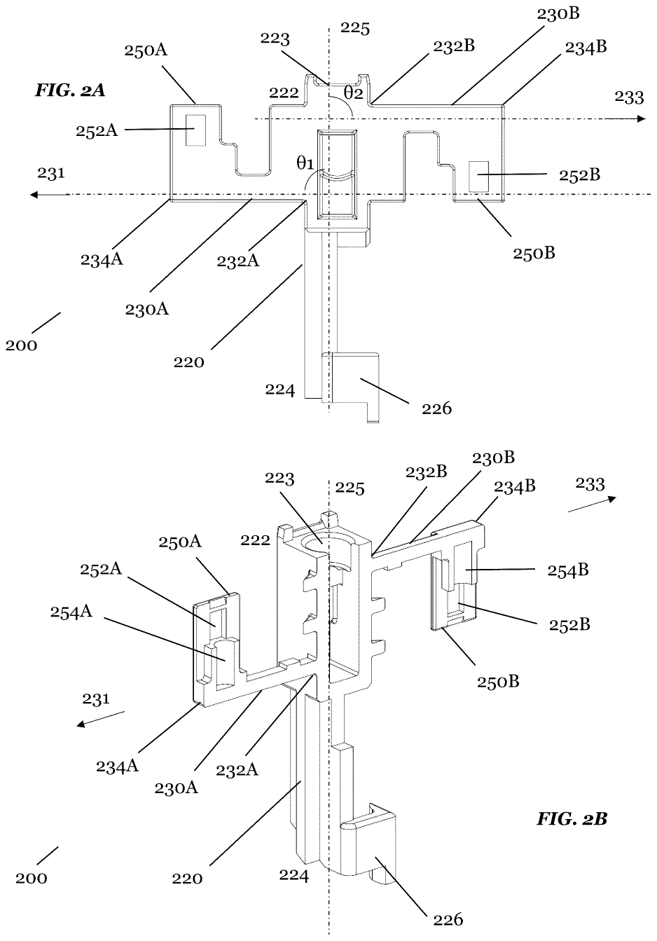

With reference to FIG. 2 (FIGS. 2A and 2B), an example slider device 200 for use in a switching mechanism having a plurality of fixed contacts is described in more detail. The example slider device 200 may be a specific example of the slider device 100 described above with reference to FIG. 1. This slider device is shown as having cascaded, or stepped, arms. This arrangement can help reduce weight of the slider device.

The first arm 230A and the second arm 230B of the slider device 200 shown in FIG. 2 are both perpendicular (i.e. at θ1, θ2 both equal to 90 degrees) to the first axis 225. This arrangement may provide a maximum distance between the first conductor and the second conductor (which can be coupled to the first arm 230A and the second arm 230B, respectively) in a direction perpendicular to the first axis, which increases electrical isolation between the two components (and any external current lines/external circuits coupled thereto). The first and second arms 230 also extend such that an angle between the first direction and the second direction about the first axis is 180 degrees; in other words, the angle between the first direction 231 (which the first arm of the slider device extends in) and the second direction 233 (which the second arm of the slider device extends in) about the first axis 225 is 180 degrees. This arrangement may provide a maximum distance between the first and second conductors in a direction about the first axis, which increases electrical isolation between the two components (and any external current lines/external circuits coupled thereto).

A first end 232A of the first arm 230A is attached to the body portion, and a first end 232B of the second arm 230B is attached to the body portion. The arms may be connected to the body portion 220 using any suitable means, such as (as discussed in reference to FIG. 1) integrally forming the body portion 220 and first and second arms 230A, 230B, mechanically or chemically coupling or otherwise joining or bonding, or using an interlocking mechanism. The second end 234A of the first arm 230A (the end of the first arm distal from the body portion in the first direction) comprises a first mounting portion 250A configured to retain a first conductor, and a second end 234B of the second arm 230B (the end of the second arm distal from the body portion in the second direction) comprises a second mounting portion 250B configured to retain a second conductor. The first mounting portion 250A and the second mounting portion 250B may be any component which facilitates the attachment of first and second conductors, respectively, to the first and second arms such that the slider 100 can carry the first and second conductors. The mounting portions 250A, 250B may be integrally formed with the arms of the slider device 200, or they may be separate components that are e.g. mechanically or chemically coupled or otherwise joined or bonded to the arms or connected via an interlocking mechanism.

The first mounting portion 250A is arranged such that the first conductor is configured to face in a direction towards the first end 222 of the body portion 220. In other words, the first conductor is orientated with a direction component parallel to the first axis extending towards the first end 222 (rather than the second end) of the body portion.

In some specific examples, the first conductor is arranged to face towards a plane defined by the first end 222 of the body portion 220. This may be a plane which includes and extends from the face of the first end of the body portion, or a plane which is tangential to the first end of the body portion. The second mounting portion 250B is arranged such that the second conductor is configured to face in a direction towards the second end 224 of the body portion 220. In other words, the second conductor is orientated with a direction component parallel to the first axis extending towards the second end 224 (rather than the first end) of the body portion. In some specific examples, the second conductor is arranged to face towards a plane defined by the second end 224 of the body portion 220. This may be a plane which includes and extends from the face of the second end of the body portion, or a plane which is tangential to the second end of the body portion. This arrangement can increase separation of the first and second conductors along the first axis, further isolating the current lines. Said isolation can be further increased when the first arm and the second arm are offset along the first axis, as illustrated in FIG. 2B.

In conjunction with placement of the fixed contacts such that some fixed contacts are arranged to face towards the first mounting portion, and others are arranged to face towards the second mounting portion, this arrangement of FIG. 2 may also allow a switching mechanism with simultaneous normally open and normally closed switching to be provided (as described above in reference to FIG. 1). In some examples, the first conductor is arranged to contact a first pair of fixed contacts of the plurality of fixed contacts in a first plane (optionally a first plane perpendicular to the first axis 225). The second conductor is arranged to contact a second pair of fixed contacts of the plurality of fixed contacts in a second plane (optionally a second plane perpendicular to the first axis 225). The first plane may be different to the second plane. In this case, this arrangement may provide a switching mechanism which efficiently makes use of space available in an external housing.

The first mounting portion 250A comprises a first through-hole 252A (e.g. a recess, an aperture, a window, a slot, or a hole) configured to interface with a protruding portion of the first conductor. An interference fit between the first through-hole 252A and the protruding portion of the first conductor constrains (i.e. limits) movement of the first conductor to motion along an axis parallel to the first axis 225 (e.g. a vertical axis). That is, the first through-hole 252A is shaped such that the protruding portion of the first conductor is allowed to move within it in directions parallel to the first axis 225, but is prevented from moving in other directions. In other words, the first conductor can move along an axis parallel to the first axis and movement is restricted along axes perpendicular to the first axis. The second mounting portion 250B comprises a second through-hole 252B configured to interface with a protruding portion of the second conductor. The second through-hole 252B may be similar to the first through-hole 252A, the protruding portion of the second conductor may be similar to the protruding portion of the first conductor, and the second through-hole 252B and protruding portion of the second conductor may interface in a manner similar to the first through-hole and protruding portion of the first conductor so that the second conductor can move along an axis parallel to the first axis and movement is restricted along axes perpendicular to the first axis. The first and second mounting portions may respectively retain the first and second conductors in place without the need for any further components.

The first mounting portion 250A also comprises a first guide-hole 254A (e.g. a recess, an aperture, a slot, or a hole) along an axis parallel to the first axis 225. The first guide-hole 254A, in conjunction with the first conductor, can retain a first resilient member. In other words, the first resilient member is retained within the first guide-hole by the first conductor. The first resilient member is made from a resiliently (e.g. elastically) deformable material. The first resilient member may be a spring, or could be a flexible component made from e.g. plastic or rubber. For example, one end of the first resilient member can be placed at least partially within the first guide-hole 254A, and the first conductor may contain a groove or indent configured to retain the other end of the first resilient member. The second mounting portion 250B comprises a second guide-hole 254B along an axis parallel to the first axis 225, which may be similar to the first guide-hole 254A. The second guide-hole 254B and the second conductor are configured to retain a second resilient member. In other words, the first resilient member is retained within the first guide-hole by the first conductor. The second resilient member may be similar to the first resilient member, and may be retained in a similar manner to the first resilient member. The first and second resilient members, when compressed, may be arranged to provide a compressive reaction force on the first and second conductors which may urge them into more secure contact with, e.g. fixed contacts of the plurality of fixed contacts. The resilient members may also facilitate movement of the first and second conductors to protect the first, second and fixed conductors from over travel of the slider 100, 200.

The first end 222 of the body portion 220 comprises a third guide-hole 223 (e.g. a recess, an aperture, a slot, or a hole) along the first axis 225. The third guide-hole 223, in conjunction with an external housing, can retain a third resilient member (which may be similar to the first and second resilient members). In other words, the third resilient member may be retained within the third guide-hole by the external housing. For example, one end of the third resilient member can be placed at least partially within the third guide-hole 223, and the external housing may contain a groove or indent configured to retain the other end of the third resilient member. The third resilient member may be arranged to act as a biasing member to urge the slider device 200 along the first axis 225 in a user independent mode of operation, providing a more rapid switching mechanism.

The slider device 200 of FIG. 2 shows an engagement portion 226 coupled to the second end 224 of the body portion 220. The first axis 225 may extend through the engagement portion 226, or the engagement portion may be offset from the first axis. The engagement portion 226 may be integrally formed with the body portion 220 of the slider device 200, or it may be a separate component which is e.g. mechanically or chemically coupled or otherwise joined or bonded to the body portion or connected via an interlocking mechanism. The engagement portion 226 may be configured to receive an external force, such as an external force intended to move the slider device 200 along the first axis 225 as part of the operation of the switching mechanism. The engagement portion 226 may be shaped to increase the surface area over which the external force is applied (as compared to e.g. the second end of the body portion), or may be shaped so as to interface with a component which applies said external force (such as a cam, a motor, or a piston).

The slider device shown in FIG. 2 is integrally formed from plastic. As described with reference to FIG. 1, integrally forming the slider device may provide a more rigid and stable component, which is less prone to bending under external forces. A modular slider device, by contrast, (despite allowing for repair or replacement of constituent components) could introduce minor misalignments or weaknesses between the body portion and arms; this could increase bending when an external force is applied to the slider device, and mean that the contact pressure which can be achieved between the conductors and the fixed contacts is reduced. An integrally formed slider device can also be manufactured more quickly and cheaply than a modular device.

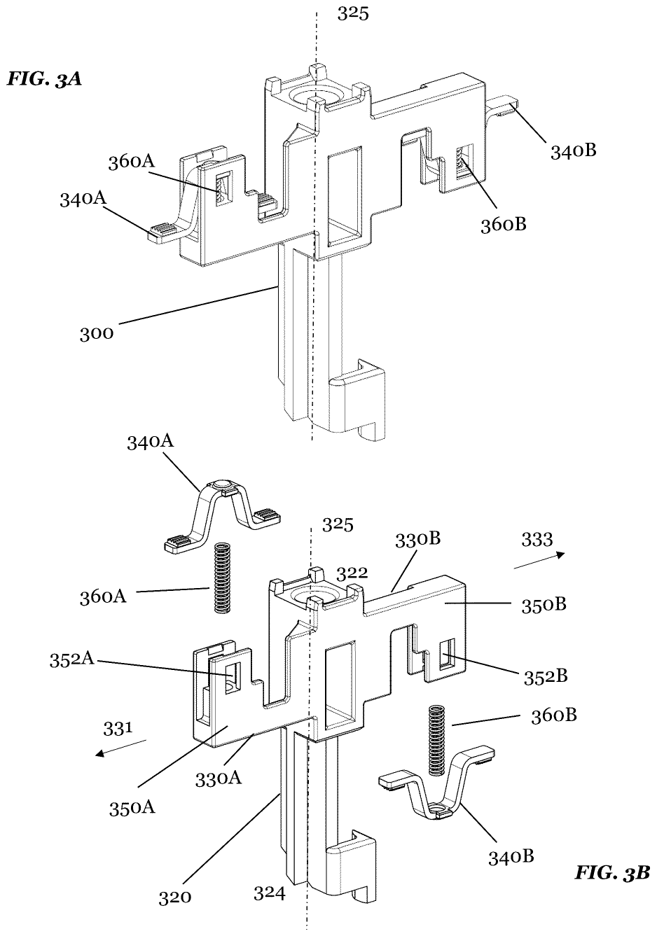

With reference to FIG. 3 (FIGS. 3A and 3B), an example apparatus is described in more detail. The apparatus comprises the slider device shown in FIG. 2 (i.e. slider device 300 may be the example slider device 200 described above with reference to FIG. 2). The apparatus also comprises a first conductor 340A carried by the first fixed arm 330A of slider device 300 and a second conductor 340B carried by the second fixed arm 330B of slider device 300. The apparatus also comprises a first resilient member 360A retained within the first guide-hole 354A (not shown in FIG. 3, see e.g. 254A in FIG. 2) by the first conductor 340A and a second resilient member 360B retained within the second guide-hole 354B (not shown in FIG. 3, see e.g. 254B in FIG. 2) by the second conductor 340B. In the example of FIG. 3, both the first and second resilient members 360A, 360B are compression springs but any other suitable resiliently deformable component may be used.

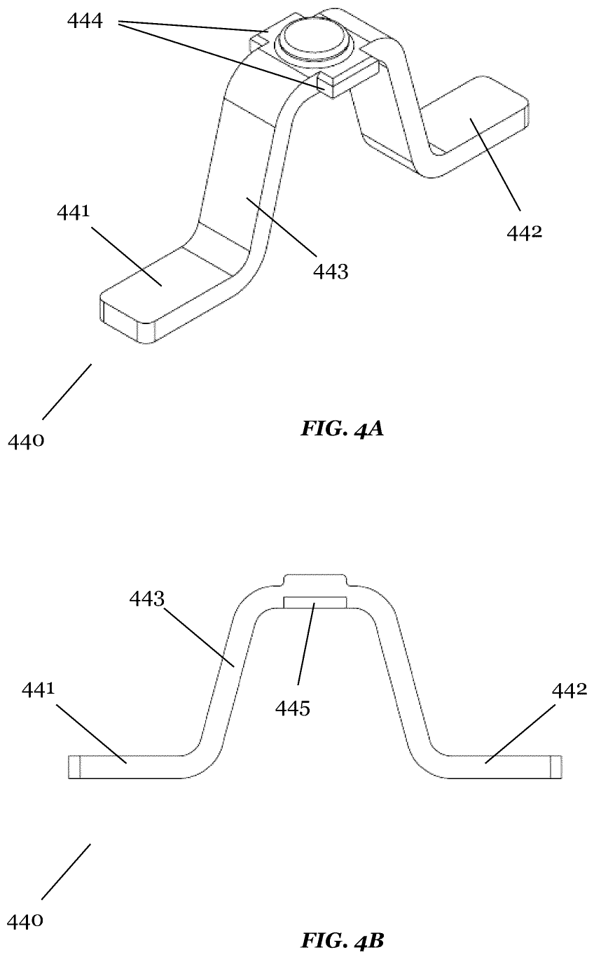

The slider device 300, first and second conductors 340A, 340B, and first and second resilient members 360A, 360B (shown in disassembled form in FIG. 3B) can be quickly and easily assembled into the apparatus (shown in assembled form in FIG. 3A). In the example of FIG. 3, one end of the first resilient member 360A is placed partially within the first guide-hole 354A of the first mounting portion 350A, and the other end of the first resilient member 360A is held by a groove or recess in the first conductor 340A (see 445 of FIG. 4 for further detail). Similarly, one end of the second resilient member 360B is placed partially within the second guide-hole 354B of the second mounting portion 350B, and the other end of the second resilient member 360B is held by a groove or recess in the second conductor 340B.

Also in this example, the first mounting portion 350A has a first through-hole 352A (in the form of a window) which interfaces with a protruding portion of the first conductor 340A (see 444 of FIG. 4 for further detail). An interference fit between the first through-hole 352A and the protruding portion of the first conductor 340A means that the first conductor can be snapped (or locked) into place, and its movement limited to movement along an axis parallel to the first axis 325 (movement guided by e.g. the first guide-hole 354A and first resilient member 360A). Similarly, the second mounting portion 350B has a second through-hole 352B (in the form of a window) which interfaces with a protruding portion of the second conductor 340B. An interference fit between the second through-hole 352B and the protruding portion of the second conductor 340B means that the second conductor can be snapped (or locked) into place, and its movement limited to movement along an axis parallel to the first axis 325 (guided e.g. by the second guide-hole 354B and second resilient member 360B).

With reference to FIG. 4 (FIGS. 4A and 4B), an example conductor (e.g. the first conductor or the second conductor as described above with reference to FIGS. 1, 2, and/or 3) is described in more detail.

The conductor 440 comprises a first contact plate 441, a second contact plate 442, and a U-shaped conductive track 443 arranged between the first contact plate 441 and second contact plate 442. The first and second contact plates may be any shape or design capable of making a strong electrical connection with e.g. the fixed contacts 112, 114, 116, 118. For example, they may be substantially flat, or may comprise ridges or grooves. The U-shaped conductive track 443 electrically connects the first contact plate 441 to the second contact plate 442, and may be shaped to accommodate the size/shape of the mounting portions and/or the length of one of the resilient members protruding from one of the guide-holes. As such, the use of a U-shaped (or e.g. curved/bucket-shaped) track can reduce the space which is necessary for the switching mechanism.

The conductor 440 comprises a protruding portion 444 at the upper edge of the U-shaped track 443. The protruding portion 444 takes the form of two edges protruding in the two directions perpendicular to the direction of the U-shaped track 443 between the two contact plates 441, 442. The conductor also comprises a groove 445 to interface with the appropriate resilient member and (in conjunction with the corresponding guide-hole) hold or retain the resilient member in place within the mounting portion.

The conductor 440 may be integrally formed of a conductive material. In this example, the conductive material may be sheet metal. For example, the shape of the conductor can be stamped from a sheet of metal of appropriate thickness, and can then be bent into shape to form the conductor. The first and second conductor can both be the same shape (i.e. manufactured to the same size and specifications), and can then be used interchangeably as either first or second conductors, as described herein. Any other manufacturing technique can be used.

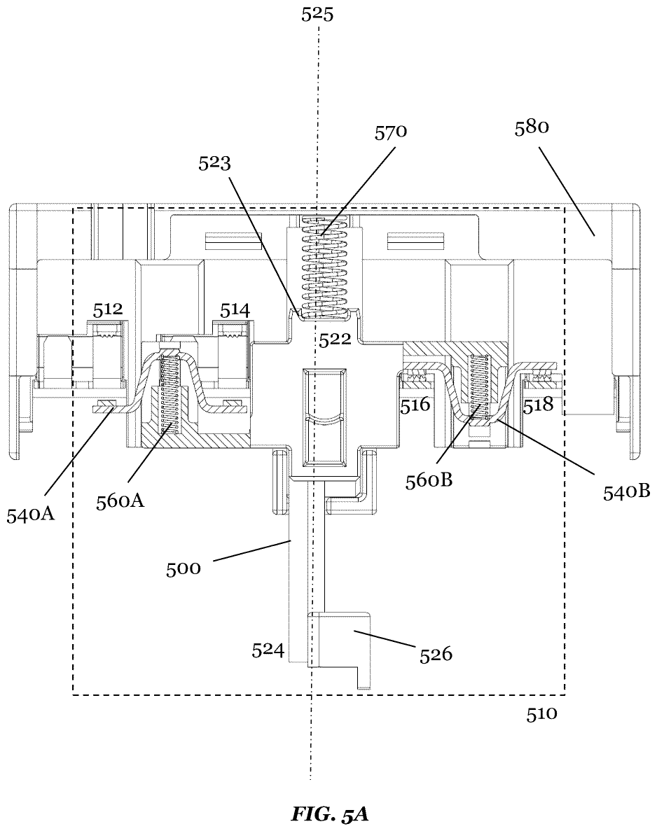

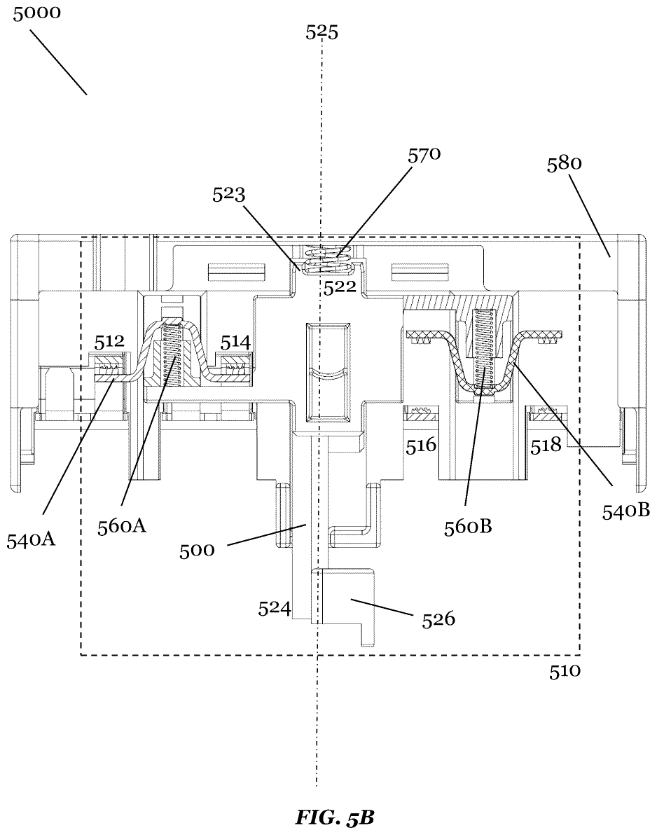

With reference to FIG. 5 (FIGS. 5A and 5B), an example switch 5000 is described in more detail.

The switch 5000 comprises an external housing 580 and a switching mechanism 510 arranged at least partially within the external housing. The external housing may enclose or partially enclose the switching mechanism, and may comprise a cavity into which the switching mechanism fits or can be disposed. The external housing may be arranged to retain the switching mechanism. For example, part of the switching mechanism 510 (i.e. one or more of the fixed contacts 512, 514, 516, 518 and associated housing/connections) and external housing 580 may interlock via a snap-fit mechanism to hold or retain the fixed contacts of the switching mechanism 510 in place whilst slider device 500 moves along axis 525 relative to the fixed contacts. This may allow for quick and/or modular manufacturing of the switch, as well as facilitating replacement of one or more components if they wear or break. Alternatively or additionally, part of the switching mechanism (i.e. one or more of the fixed contacts 512, 514, 516, 518) may be mechanically or chemically coupled or joined or bonded to or otherwise attached/connected to the external housing.

The switching mechanism comprises an apparatus corresponding to the apparatus as described above with reference to FIG. 3 (i.e. the apparatus comprising slider device 300, first and second conductors 340A, 340B, and optionally first and second resilient members 360A, 360B, assembled as demonstrated in FIG. 3A). The switching mechanism also comprises a third resilient member 570 as described above in relation to FIG. 2, which is a compression spring in the example of FIG. 5. The third resilient member is retained within the third guide-hole 523 by the external housing 580 by placing the third resilient member at least partially within the third guide-hole prior to instalment or disposing of the switch mechanism 510 within the external housing 580. The external housing may contain a groove or indent (similar to the first and second conductors) configured to brace and hold the other end of the third resilient member in place.

The switching mechanism also comprises a plurality of fixed contacts 512, 514, 516, 518, which may be similar to the fixed contacts described above, for example, in relation to FIG. 1. The plurality of fixed contacts comprise a first pair of fixed contacts 512, 514 configured to be coupled to one or more first external current lines 513 (not shown in FIG. 5) of the one or more external current lines, and a second pair of fixed contacts 516, 518 configured to be coupled to one or more second external current lines 517 (not shown in FIG. 5) of the one or more external current lines. In the illustrated example of FIG. 5, the switching mechanism comprises a first fixed contact 512 and a second fixed contact 514 (i.e. the first pair of fixed contacts) which are in electrical contact with a first portion of a first external current line 513A and a second portion of the first external current line 513B, respectively. The switching mechanism also, in this example, comprises a third fixed contact 516 and a fourth fixed contact 518 (i.e. the second pair of fixed contacts) which are in electrical contact with a first portion of a second external current line 517A and a second portion of the second external current line 517B, respectively.

The external housing 580 may, in some examples, retain the plurality of fixed contacts 512, 514, 516, 518. The fixed contacts may be formed from any suitable electrically conducting material, optionally copper. Such fixed contacts may be bolted or screwed into the external housing, or otherwise mechanically coupled to the external housing, or the contacts may be bonded, adhered or moulded into the external housing, as appropriate. It will be understood that alternative configurations of the housing are possible which, for example, do not include specific fixed contacts shown in FIG. 5, with other electrically connecting components or terminals used instead.

As explained above, current conduction paths can be defined along external current lines 513, 517 and through the switch 5000, and the switch comprises a switching mechanism 510 which is configured to open and close the current conduction path(s) by movement of the slider device 500.

FIG. 5A illustrates an example with the slider device 500 in a first position. In this first position, the first conductor 540A is electrically separate from the first pair of fixed contacts 512, 514 (the first fixed contact and the second fixed contact), and the second conductor 540B is electrically connected to second external current line 517 by way of the second pair of fixed contacts 516, 518 (the third fixed contact and the fourth fixed contact). However, it will be understood that alternative arrangements of the current conduction path are possible which, for example, do not include the specific fixed contacts of FIG. 5, or have a different arrangement of connections in the first position of the slider device 500. Moreover, although FIG. 5A shows the second conductor electrically connected to the second pair of fixed contacts with the second external current line closed in the first position, it will be appreciated that alternatively, the second conductor could be electrically separated from the second external current line in the first position (i.e. the second conductor and/or the second pair of fixed contacts may be otherwise positioned).

In this particular illustrated example, the current conduction path through the switch comprises the first portion of the second external current line 517A, the third fixed contact 516, the second conductor 540B, the fourth fixed contact 518, and the second portion of the second external current line 517B. Thus, a closed current conduction path is provided from the first portion of the second external current line 517A to the second portion of the second external current line 517B through the second conductor, and an electrical current carried by the second external current line is permitted to flow through the switch 5000.

In the example of FIG. 5A, the slider device 500 is in the first position prior to any significant external forces acting on the switching mechanism 510 (i.e. no forces other than the internal weight and reaction forces of the components of the switch itself). The switching mechanism may be considered to be in equilibrium. In some examples, the third resilient member 570 may be completely uncompressed or undeformed (or may be only minimally compressed/deformed). In this position, where used, the second resilient member 560B may be at least partially resiliently deformed such that the second resilient member 560B exerts a force on the second conductor 540B which urges the second conductor towards the second pair of fixed contacts 516, 518 (e.g. pushing it against the second pair of fixed contacts). In other words, in the first position, the second resilient member can be configured to exert a force on the second conductor to urge the second conductor into electrical contact with the second pair of fixed contacts. This approach can provide a more robust electrical connection and can help prevent opening of the current conduction path in response to external impulse forces, for example.

In operation, an external force is applied to the engagement portion 526 of the slider device 500. This external force is applied substantially along the first axis 525 and towards the first end 522 of the body portion 520. Forces may be applied to the engagement portion of the slider device in a direction other than along the first axis, but such forces may nonetheless provide a force component along the first axis which may act as the external force. Applying an external force to the engagement portion of the slider device, the forced applied along the first axis in a direction towards the first end of the body portion, acts to move the slider along the first axis. Movement of the slider exerts a compressive force on the third resilient member. In other words, the force exerted on the third resilient member by the slider device (and the reaction force from the housing) provides a compressive force to the third resilient member along the first axis. The compressive force causes the third resilient member to resiliently (for example, elastically) deform, along the first axis. The degree to which the third resilient member elastically deforms (for a given stiffness or bending stiffness of the third resilient member) will be proportional to the magnitude of the external force applied.

It will be understood that the compression and deformation of the third resilient member facilitates further sliding or movement of the slider device 500. In other words, deformation of the third resilient member allows the slider device to continue to move along the first axis in the direction of the applied external force. The external housing 580 of the switch 5000 may be configured such that motion of the slider device is substantially confined to motion along the first axis. As such, force components acting on the slider device in a direction different from (for example, perpendicular to) the first axis may only cause negligible lateral motion of the slider device.

In the illustrated example of FIG. 5, with the external force applied and following the resilient (elastic) deformation of the third resilient member 570, the switching mechanism 510 is displaced to a second position. In particular, as the external force is applied, the deformation of the third resilient member 570 allows the slider device 500 to move further along the first axis 525 in a direction pointing towards the first end 522 of the body portion 520, from the first position to the second position. As explained above, the slider device is configured to directly carry the first and second conductors 540A, 540B. The distance between the first position and the second position of the slider device (for a given stiffness or bending stiffness of the third resilient member) will be proportional to the magnitude of the external force applied to the slider device. FIG. 5B shows the slider device 500 in the second position. In this example of the second position, the first conductor 540A is electrically connected to the first external current line 513 by way of the first pair of fixed contacts 512, 514 (the first fixed contact and the second fixed contact), and the second conductor 540B is electrically separate from the second pair of fixed contacts 516, 518 (the third fixed contact and the fourth fixed contact). In this illustrated example, the current conduction path through the switch comprises the first portion of the first external current line 513A, the first fixed contact 512, the first conductor 540A, the second fixed contact 514, and the second portion of the first external current line 513B. Thus, a closed current conduction path is provided from the first portion of the first external current line 513A to the second portion of the first external current line 513B, and an electrical current carried by the first external current line is permitted to flow through the switch. However, it will be understood that other arrangements are possible. For example, although FIG. 5B shows the second conductor electrically separated from the second external current line in the second position, it will be appreciated that alternatively, the second conductor could be electrically connected to the second external current line in the second position.

In this second position, the first resilient member 560A may be at least partially resiliently deformed such that the first resilient member exerts a force on the first conductor 540A which urges the first conductor towards the first pair of fixed contacts 512, 514 (e.g. pushing it against the first pair of fixed contacts). In other words, in the second position, the first resilient component can be configured to exert a force on the first conductor to urge the first conductor into electrical contact with the first pair of fixed contacts. This approach can provide a more robust electrical connection and can help prevent opening of the current conduction path in response to external impulse forces, for example.

With the slider device 500 in the second position, the external force may then be removed. In response to the removal of the external force, the third resilient member 570 is arranged to act on the slider device 500 as a biasing member. The third resilient member is configured to urge the slider device 500 along the first axis 525, in a direction towards the second end 524 of the body portion 520; in this way, the third resilient member is configured to urge the slider device to move from the second position towards the first position. In other words, upon removal of the applied external force the resiliently or elastically deformed third resilient member returns to its initial equilibrium (undeformed or only minimally deformed) state, and this decompressing and subsequent expansion of the third resilient member along the first axis provides a biasing force which causes the slider device to move along the first axis in a direction towards the second end of the body portion, or from the second position to the first position.

The external force may be provided by a linear actuation of the slider device, or by rotational actuation from an external device, for example by a cam. For example, the cam may be coupled to a handle to allow a user to rotate the cam to provide a rotary motion (i.e. a torque) to operate the switching mechanism. This may require less effort than a linear actuator and therefore be easier for a user than providing a linear force, thus improving accessibility. A more compact switch may also be provided.

As explained above in reference to FIG. 1, the slider device 500 of switch 5000 provides physical separation between the first conductor 140A and the second conductor 140B. The slider device therefore provides electrical isolation between the first external current line 513 and the second external current line 517. The design of slider device 500 maximises the distance between the components of the two separate circuit, thus providing optimal clearance and creepage distance between the two conductors for any given external housing 580 size. Increasing the electrical isolation of the switch 5000 helps to reduce the chance of short circuiting, arcing, and electromagnetic or other electrical interference.

The particular arrangement of conductors and fixed contacts in FIG. 5 provides a switching mechanism 510 which can provide simultaneous normally open and normally closed switching (i.e. in one position of the slider device, a first current conduction path is closed and a second current conduction path is open, whilst in another position of the slider device, the first current conduction path is open and the second current conduction path is closed). It is particularly important to make sure that these current conduction paths are electrically isolated from one another. For example, a short circuit between two loads, one of which is meant to be ‘powered on’ by default and one of which is meant to be ‘powered off’ by default could potentially be dangerous or hazardous. The design described herein provides this necessary electrical isolation by way of the horizontal (in a direction perpendicular to the first axis) and/or vertical (along the first axis) separation or offset of the first and second conductors.

The slider device 500 shown in FIG. 5 can be integrally formed from plastic. As described with reference to FIG. 1, integrally forming the slider device may provide a more rigid and stable component, which is less prone to bending under external forces. It is important to reduce bending of the fixed arms as much as possible, in order to create a strong electrical contact between the conductors and the fixed contacts.

Moreover, the switching mechanism 510 described herein uses fixed arms to carry the conductors away from the main body portion of the slider device. This removes the need to have longer conductors extending directly from the central main body portion, which may be more prone to bending than smaller conductors of the same thickness.

The fixed arms can be sufficiently dimensioned to create a slider device which is substantially unbending when subject to standard switching external forces. This creates a robust, reliable switching mechanism.

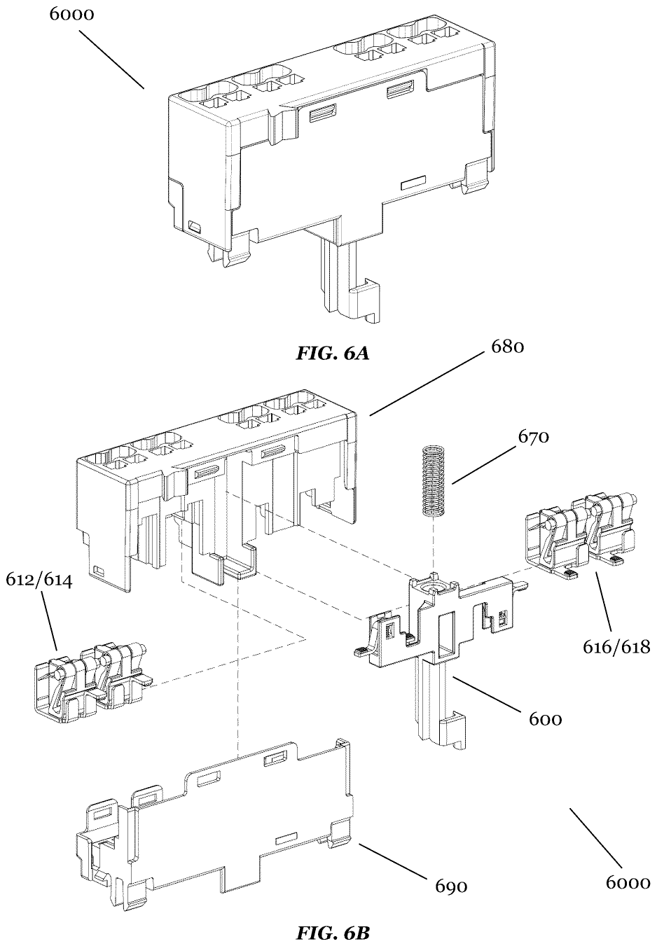

With reference to FIG. 6 (FIGS. 6A and 6B), an example switch 6000 is described in more detail.

The switch 6000 may be the example switch 5000 described above with reference to FIG. 5. The switch 6000 comprises a slider device 600 (which may be the same as the slider device 500 described above with reference to FIG. 5), a third resilient member 670 (which may be the same as the third resilient member 570 described above with reference to FIG. 5), and an external housing 680 (which may be the same as the external housing 580 described above with reference to FIG. 5). The switch 6000 may also comprise some or all of the other components described above in relation to the example switch 5000 shown in FIG. 5.

The switch 6000 comprises a first pair of fixed contacts (which may be the same as the first pair of fixed contacts 512, 514 described above with reference to FIG. 5) provided in the form of first fixed contact block 612/614 (which comprises a first fixed contact 612 and a second fixed contact 614). The switch 6000 also comprises a second pair of fixed contacts (which may be the same as the second pair of fixed contacts 516, 518 described above with reference to FIG. 5) provided in the form of second fixed contact block 616/618 (which comprises a third fixed contact 616 and a fourth fixed contact 618).

The external housing 680 may interlock with the first fixed contact block 612/614 via a snap-fit mechanism. The external housing 680 may interlock with the second fixed contact block 616/618 via a snap-fit mechanism. This may allow for quick and/or modular manufacturing of the switch, as well as facilitating replacement of one or more components if they wear or break. Alternatively or additionally, or the first and/or second fixed contact block may be retained within the external housing in any other suitable manner; for example, the external housing 680 may be mechanically or chemically coupled or joined or bonded to or otherwise attached/connected to first fixed contact block 612/614 and/or second fixed contact block 616/618.

The switch 6000 also comprises a cover 690. The cover 690 may be attached to the external housing 680 to cover the slider device 600, contact blocks 612/614, 616/618, third resilient member 670, etc. This cover 690 may be bonded onto the external housing 680, or may interlock with the external housing 680 via a snap-fit mechanism or interference fit. The cover 690 may provide electrically insulating protection to a user of the switch from potentially exposed electrical components (e.g. first and second conductors, first fixed contact block 612/614, second fixed contact block 616/618). This cover 690 may also protect the switching mechanism of switch 6000 from damage (e.g. from external environmental conditions). The interlocking between the housing 680 and cover 690 allows slider device 600 to move freely in a linear direction between the housing and the cover, and can help to restrict movement of the slider device 600 in other directions.

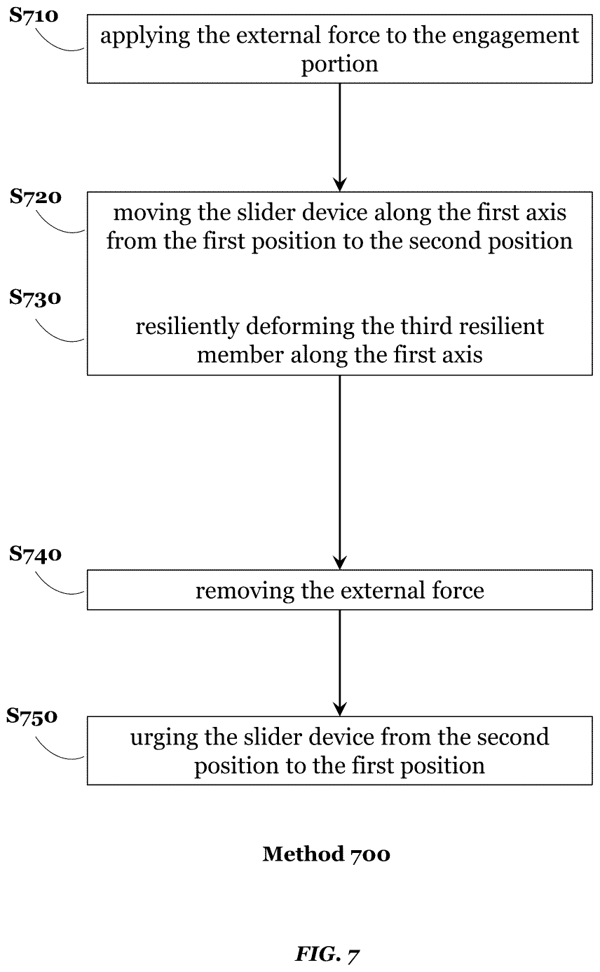

With reference to FIG. 7, a method 700 for operating a switch configured for connection to one or more external current lines (for example, the switch described above with reference to FIGS. 5 and/or 6) is described.

At step 710, the method comprises applying the external force to the engagement portion. The external force may be applied gradually or instantaneously. Optionally, the external force is provided by a cam, where the switch further comprises the cam. The cam applies the external force to the engagement portion of the body portion of the slider device when the cam is in a first rotational position. For example, a user may turn a handle coupled to the cam (by e.g. optionally 90 degrees in a first rotational direction) to apply the external force. In other examples, the external force may be provided by a linear actuator.

In response to the application of the external force, at step 720, the method comprises moving the slider device along the first axis from the first position to the second position, thereby resiliently deforming 730 the third resilient member along the first axis. The external force causes the engagement portion of the slider device to move along the first axis, and exerts a compressive force on the third resilient member. A reaction force may also be exerted on the third resilient member by the external housing. This reaction force may be provided at the part of the housing which fixedly retains the third resilient member. The force exerted on the third resilient member by the slider device (and the reaction force from the external housing) causes the third resilient member to resiliently deform and compress along the first axis. The movement of the slider device from the first position to the second position is facilitated by the resilient deformation of the third resilient member. As the third resilient member resiliently deforms, the slider device carries the first and second conductors parallel to the first axis by a distance dependent on the deformation of the third resilient member.

At step 740,the method comprises removing the external force. The external force may be removed gradually or instantaneously. Where the external force is provided by a cam, the external force may be removed from the engagement portion of the body portion of the slider device when the cam is in a second rotational position (different to the first rotational position). For example, a user may turn a handle coupled to the cam (by e.g. optionally 90 degrees in a direction opposite to the first rotational direction) to remove the external force.

In response to the remove of the external force, at step 750, the method comprises urging, by the third resilient member, the slider device from the second position to the first position. Operation at step 750 can be user independent. Upon removal of the external force, the elastically deformed third resilient member returns to its equilibrium (non-deformed or partly, optionally minimally, deformed) state, and this movement of the third resilient member provides a biasing force which pushes the slider device along the first axis from the second position to the first position.

It is noted herein that while the above describes various examples of the slider device of the first aspect, the apparatus of the second aspect, the switch of the third aspect, and the method of the fourth aspect, these descriptions should not be viewed in a limiting sense. Rather, there are several variations and modifications which may be made without departing from the scope of the presently disclosed subject matter as defined in the appended claims.

1. A slider device for use in a switching mechanism having a plurality of fixed contacts, the slider device comprising:
a body portion extending along a first axis between a first end and a second end;
a first fixed arm extending away from the body portion in a first direction; and
a second fixed arm extending away from the body portion in a second direction, wherein the first direction is different to the second direction, and wherein the first direction and the second direction each extend at an angle to the first axis;
wherein the first arm is configured to carry a first conductor, and wherein the second arm is configured to carry a second conductor.

2. The slider device as claimed in claim 1, wherein the first direction and the second direction are both perpendicular to the first axis.

3. The slider device as claimed in claim 2, wherein an angle between the first direction and the second direction about the first axis is 180 degrees.

4. The slider device as claimed in claim 1, wherein the first arm and the second arm are offset along the first axis.

5. The slider device as claimed in claim 1, wherein the slider device is integrally formed; or
wherein the body portion, the first fixed arm, and the second fixed arm are manufactured as separate components and coupled together to form the slider device.

6. The slider device as claimed in claim 5, wherein the slider device is formed from an insulating material,
optionally, wherein the insulating material is plastic.

7. The slider device as claimed in any claim 1, wherein:
a first end of the first arm is attached to the body portion, and wherein a second end of the first arm comprises a first mounting portion configured to retain the first conductor; and
a first end of the second arm is attached to the body portion, and wherein a second end of the second arm comprises a second mounting portion configured to retain the second conductor.

8. The slider device as claimed in claim 7, wherein:
the first mounting portion is arranged such that the first conductor is configured to face in a direction towards the first end of the body portion; and
the second mounting portion is arranged such that the second conductor is configured to face in a direction towards the second end of the body portion.

9. An apparatus for use in a switching mechanism having a plurality of fixed conductors, comprising:
a slider device according to claim 7;
a first conductor retained by the first mounting portion; and
a second conductor retained by the second mounting portion.

10. The apparatus as claimed in claim 9, wherein:
the first mounting portion comprises a first through-hole configured to interface with a protruding portion of the first conductor such that the first conductor can move along an axis parallel to the first axis and movement is restricted along axes perpendicular to the first axis; and
the second mounting portion comprises a second through-hole configured to interface with a protruding portion of the second conductor such that the second conductor can move along an axis parallel to the first axis and movement is restricted along axes perpendicular to the first axis.

11. The apparatus as claimed in claim 10, wherein:
the first mounting portion further comprises a first guide-hole configured to receive a first resilient member; and
the second mounting portion further comprises a second guide-hole configured to receive a second resilient member.

12. The apparatus as claimed in claim 11, further comprising a first resilient member retained within the first guide-hole by the first conductor and a second resilient member retained within the second guide-hole by the second conductor,
optionally, wherein the first resilient member and/or the second resilient member is a spring.

13. The apparatus as claimed in claim 9, wherein:
the first conductor is arranged to contact a first pair of fixed contacts of the plurality of fixed contacts in a first plane; and
the second conductor is arranged to contact a second pair of fixed contacts of the plurality of fixed contacts in a second plane,
optionally, wherein the first plane and/or the second plane are perpendicular to the first axis.

14. The apparatus of any as claimed in claim 9, wherein the first conductor and second conductor each comprise:
a first contact plate;
a second contact plate;
a U-shaped conductive track arranged between the first contact plate and second contact plate.

15. The apparatus as claimed in claim 14, wherein the first conductor is integrally formed of a conductive material and/or wherein the second conductor is integrally formed of a conductive material,
optionally, wherein the conductive material is sheet metal.

16. The apparatus as claimed in any of claim 9, wherein the first conductor and second conductor have a same shape.

17. A switch configured for connection to one or more external current lines, comprising:
an external housing;
a switching mechanism arranged at least partially within the external housing and comprising:
the apparatus as claimed in claim 9; and
a plurality of fixed contacts, the plurality of fixed contacts comprising a first pair of fixed contacts configured to be coupled to one or more first external current lines of the one or more external current lines, and a second pair of fixed contacts configured to be coupled to one or more second external current lines of the one or more external current lines.

18. The switch as claimed in claim 17, wherein:
the first end of the body portion comprises a third guide-hole along the first axis, wherein the third guide-hole, the switch further comprising a third resilient member retained within the third guide-hole by the external housing.

19. The switch as claimed in claim 18, wherein the third resilient member is a spring.

20. The switch as claimed in claim 18, wherein the second end of the body portion comprises an engagement portion configured to receive an external force for operating the switching mechanism, and
wherein, in response to application of an external force to the engagement portion directed along the first axis and towards the first end of the body portion, the slider device is configured to move along the first axis from a first position to a second position, and thereby cause the third resilient member to resiliently deform, and
wherein, in response to removal of the external force, the third resilient member is arranged to urge the slider device to move along the first axis from the second position towards the first position.

21. The switch as claimed in claim 20, wherein:
in one of the first and second positions, the first conductor is configured to electrically connect the first pair of fixed contacts such that a current can flow through the one or more first external current lines, and the second conductor is electrically separate from the second pair of fixed contacts; and
in the other of the first and second positions, the first conductor is electrically separate from the first pair of fixed contacts, and the second conductor is configured to electrically connect the second pair of fixed contacts such that a current can flow through the one or more second external current lines.

22. The switch as claimed in claim 21, wherein the first resilient member is configured to exert a force on the first conductor to urge the first conductor into electrical contact with the first pair of fixed contacts and/or wherein the second resilient member is configured to exert a force on the second conductor to urge the second conductor into electrical contact with the second pair of fixed contacts.

23. The switch as claimed in claim 21, wherein:
the first conductor is arranged such that, in one of the first and second positions, the first contact plate and second contact plate of the first conductor form the electrical connection with respective fixed contacts of the first pair of fixed contacts such that the current can flow through the one or more first external current lines; and
the second conductor is arranged such that, in the other of the first and second positions, the first contact plate and second contact plate of the second conductor form the electrical connection with respective fixed contacts of the second pair of fixed contacts such that the current can flow through the one or more second external current lines.

24. A method of operating a switch configured for connection to one or more external current lines as claimed in claim 20, wherein the method comprises:
applying the external force to the engagement portion;
in response to the application of the external force, moving, by the deformation of the third resilient member, the slider device along the first axis from the first position to the second position and thereby resiliently deforming the third resilient member along the first axis;
removing the external force; and
in response to the removal of the external force, urging, by the third resilient member, the slider device from the second position to the first position.
